(19) United States
(12) Patent Application Publication
(10) Pub. No.: US 2017/0180760 A1
(43) Pub. Date: Jun. 22, 2017

(54) METHOD, ELECTRONIC DEVICE AND SYSTEM FOR ACQUIRING VIDEO PROGRAM

(71) Applicants: Le Holdings (Beijing) Co., Ltd., Beijing (CN); LeCloud Computing Co., Ltd., Beijing (CN)

(72) Inventor: Xiaoguang ZHU, Beijing (CN)

(21) Appl. No.: 15/357,739

(22) Filed: Nov. 21, 2016

Related U.S. Application Data
(63) Continuation of application No. PCT/CN2016/097220, filed on Aug. 29, 2016.

(30) Foreign Application Priority Data
Dec. 22, 2015 (CN) 201510968970.5

(51) Int. Cl. H04N 21/234; H04N 21/6402; H04N 21/6377; H04N 21/2381; H04N 21/643

(52) U.S. Cl. CPC H04N 21/234; H04N 21/2381; H04N 21/64322; H04N 21/6377; H04N 21/6402

(57) ABSTRACT

Disclosed are a method, an electronic device and a system for acquiring a video program. The method includes: receiving a video program acquiring request sent by a client; acquiring, from a preset router list, identification information of a router whose public IP address is identical to the IP address of the client, wherein the preset router list preserves identification information of a plurality of routers and a public IP address corresponding to each router; determining whether the identification information of the video program is present in a video program list corresponding to the identification information of the router; and sending the identification information of the router to the client if the identification information is present so that the client requests to acquire the video program from the router corresponding to the identification information.

### CROSS REFERENCE TO RELATED APPLICATIONS

This application is a continuation of International Application No. PCT/CN2016/097220, filed on Aug. 29, 2016, which is based upon and claims priority to Chinese Patent Application No. 201510968970.5, filed on Dec. 22, 2015, the entire contents of which are incorporated herein by reference.

### TECHNICAL FIELD

The disclosure relates to information technologies, and more particularly, to a method, an electronic device and a system for acquiring a video program.

### BACKGROUND

With constant development of information technologies, watching television programs or video programs has become one of the most common entertainment modes in people's lives. To improve user experience in watching video programs, video program downloading platforms emerge naturally. Users may download video programs from the video program downloading platforms by means of clients, and then watch the video programs on the clients locally.

At present, to improve a speed in downloading video programs, clients generally acquire video programs through content delivery network (CDN) servers corresponding to the video program downloading platforms, namely, the clients send video program downloading requests to the CDN servers, and the CDN servers send video programs corresponding to the requests to the clients through the Internet. However, there are many network nodes in the Internet and the number of network hops is large, which causes a low speed in downloading video programs and buffering of the video programs when they are started playing, thereby causing a lower speed in starting playing the video programs.

### SUMMARY

The present disclosure provides a method, an electronic device and a system for acquiring a video program to resolve a defect of a lower speed in starting playing video programs in the prior art.

In a first aspect, embodiments of the present disclosure provide a method for acquiring a video program, applied to a P2P server, including:

receiving, by the P2P server, a video program acquiring request sent by a client, where the video program acquiring request carries identification information of a video program and an IP address of the client;

acquiring, from a preset router list, identification information of a router whose public IP address is identical to the IP address of the client, where the preset router list preserves identification information of a plurality of routers and a public IP address corresponding to each router;

determining whether the identification information of the video program is present in a video program list corresponding to the identification information of the router; and

sending the identification information of the router to the client if the identification information is present so that the client requests to acquire the video program from the router corresponding to the identification information.

In a second aspect, embodiments of the present disclosure provide another method for acquiring a video program, applied to a client, including:

sending a video program acquiring request by a client to a P2P server, where the video program acquiring request carries identification information of a video program and an IP address of a client so that when the P2P server determines identification information of a router whose public IP address is identical to the IP address of the client and the identification information of the video program is present in a corresponding video program list, the P2P server sends the identification information of the router to the client;

receiving the identification information of the router sent by the P2P server;

sending a video program acquiring request to a router corresponding to the identification information so that the router sends the video program; and

receiving the video program sent by the router.

In a third aspect, embodiments of the present disclosure further provide an electronic device, including: at least one processor; and a memory communicably connected with the at least one processor for storing instructions executable by the at least one processor, wherein execution of the instructions by the at least one processor causes the at least one processor to perform any methods for acquiring a video program mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for acquiring a video program in accordance with some embodiments;

FIG. 2 is a flowchart of another method for acquiring a video program in accordance with some embodiments;

FIG. 3 is a schematic structural diagram of a P2P server in accordance with some embodiments;

FIG. 4 is a schematic structural diagram of a client in accordance with some embodiments;

FIG. 5 is a schematic structural diagram of a system for acquiring a video program in accordance with some embodiments;

FIG. 6 is a schematic diagram of an entity structure of a P2P server in accordance with some embodiments; and

FIG. 7 is a schematic diagram of a hardware structure of an electronic device performing the method for acquiring a video program in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure.

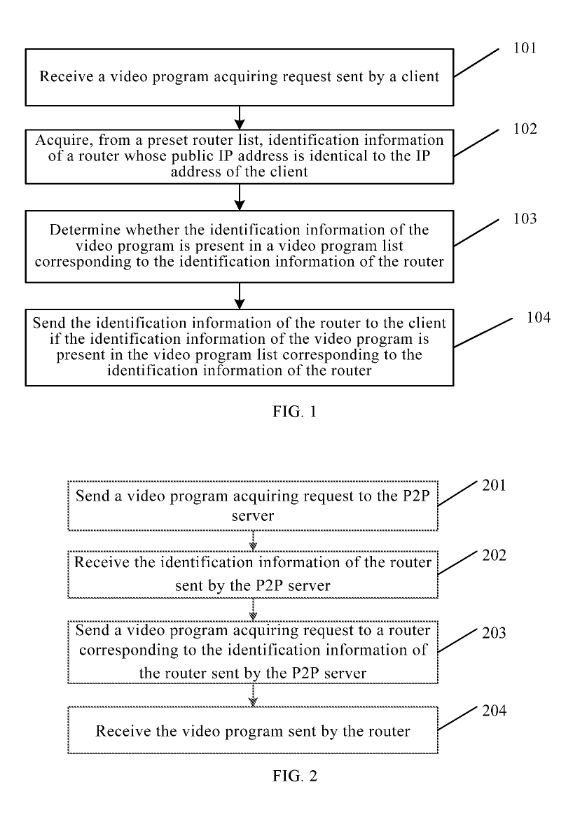

Embodiments of the present disclosure provide a method for acquiring a video program, which can be applied to a P2P server, as shown in FIG. 1, the method includes following steps.

101: A video program acquiring request sent by a client is received.

The video program acquiring request carries identification information of a video program and an Internet Protocol (IP) address of the client. The identification information of the video program can be a name of the video program or can be an identity (ID) of the video program, which is not limited in the embodiments of the present disclosure. The client can be a mobile phone, or can be a computer or a tablet computer, etc. The IP address of the client can be 192.1.1.183. In a P2P network, various nodes are equal peer nodes, where each node not only can obtain services from other nodes but also can provide services to other nodes.

102: Identification information of a router whose public IP address is identical to the IP address of the client is acquired from a preset router list.

The preset router list preserves identification information of a plurality of routers and a public IP address corresponding to each router. The identification information of a router can be a name such as Xiaoming of the router, or can be an ID of the router, which is not limited in the embodiments of the present disclosure. If the public IP address of a router is the same as the IP address of the client, this indicates that the router and the client are positioned in the same LAN. At the moment, the client downloads video programs by means of the router. In this way, a number of network hops can be reduced, and a speed in downloading video programs can be improved, thereby improving a speed in starting playing video programs.

103: It is determined whether the identification information of the video program is present in a video program list corresponding to the identification information of the router.

Identification information of different video programs is preserved in the video program list. A video program corresponding to the identification information of the video program in the video program list is downloaded by the router from a CDN server. A process of downloading a video program by the router from the CDN server may be specifically as below: a video program list sent by the CDN server is received, the video program list preserves identification information of a plurality of video programs; a video program downloading request is sent to the CDN server according to the identification information of the video program so that the CDN server sends a video program corresponding to the identification information of the video program to the router. When storage space of the router is full, requesting to download video programs from the CDN server is stopped, and a downloaded video program list is sent to the P2P server.

It is to be noted that a large number of video programs are cached in the CDN server, and the CDN server can perform statistical calculation on currently popular video programs in the form of a list, and then send the popular video programs to the router. For example, the currently popular video programs include: a video program 1-a video program 100. The CDN server sends identification information respectively corresponding to the video program 1-the video program 100 to the router in the form of a video program list. After receiving the video program list, the router can download popular video programs according to order from top to bottom from the video program list until the storage space of the router is full. For example, the storage space is full when the router downloads from the video program 1 to the video program 80. At the moment, the router sends identification information respectively corresponding to the downloaded video program 1-the video program 80 to the P2P server.

To the embodiments of the present disclosure, after Step 103, the method specifically may further include: sending prompt information to the client if the identification information of the video program is present in the video program list corresponding to the identification information of the router, where the prompt information is used for prompting the client to request to acquire the video program from the CDN server. A specific content of the prompt information may be empty. By sending the prompt information to the client, a user can timely learn about acquiring a video program. When a requested video program is not present in the router, the user can download the video program in other ways. For example, the user can acquire the video program from the CDN server. In this way, user experience can be improved.

104: The identification information of the router is sent to the client if the identification information of the video program is present in the video program list corresponding to the identification information of the router.

Further, it is convenient for the client to request to acquire the video program from the router corresponding to the identification information.

For example, the router whose public IP address is the same as the IP address of the client is a router 1, the video program requested by the client is a video program 1, if identification information of the video program 1 is present in the video program list corresponding to the router 1, the P2P server sends the identification information of the router 1 to the client so that the client can request the video program 1 from the router 1.

Embodiments of the present disclosure provide a method for acquiring a video program. A client downloads video programs from a router whose public IP address is the same as an IP address of the client, namely, the client downloads video programs by means of the router. In this way, a defect in the prior art that a client downloads video programs by means of a CDN server is changed, a number of network hops is reduced, and a speed in downloading video programs is improved, thereby improving a speed in starting playing video programs.

Embodiments of the present disclosure provide another method for acquiring a video program, which can be applied to a client, as shown in FIG. 2, the method includes following steps.

201: A video program acquiring request is sent to the P2P server.

The video program acquiring request carries identification information of a video program and an IP address of the client. The identification information of the video program can be a name of the video program or can be an ID of the video program, which is not limited in the embodiments of the present disclosure. The client can be a mobile phone, or can be a computer or a tablet computer, etc.

Further, it is convenient that when the P2P server determines identification information of a router whose public IP address is the same as the IP address of the client and the identification information of the video program is present in a corresponding video program list, the P2P server sends the identification information of the router to the client.

To the embodiments of the present disclosure, if the public IP address of a router is the same as the IP address of the client, this indicates that the router and the client are positioned in the same LAN. At the moment, the client downloads video programs by means of the router. In this way, a number of network hops can be reduced, and a speed in downloading video programs can be improved, thereby improving a speed in starting playing video programs.

To the embodiments of the present disclosure, after Step 201, the method specifically may further include: receiving prompt information sent by the P2P server, where the prompt information is used for prompting the client to request to acquire the video program from a CDN server. A specific content of the prompt information may be empty. By sending the prompt information to the client, a user can timely learn about acquiring a video program. When a requested video program is not present in the router, the user can download the video program in other ways. For example, the user can acquire the video program from the CDN server. In this way, user experience can be improved.

202: The identification information of the router sent by the P2P server is received.

203: A video program acquiring request is sent to a router corresponding to the identification information of the router sent by the P2P server.

204: The video program sent by the router is received.

Embodiments of the present disclosure provide another method for acquiring a video program. A client downloads video programs from a router whose public IP address is the same as an IP address of the client, namely, the client downloads video programs by means of the router. In this way, a defect in the prior art that a client downloads video programs by means of a CDN server is changed, a number of network hops is reduced, and a speed in downloading video programs is improved, thereby improving a speed in starting playing video programs.

Further, as a concrete implementation of the method as shown in FIG. 1, embodiments of the present disclosure provide a P2P server, as shown in FIG. 3, the P2P server includes: a receiving unit 31, an acquiring unit 32, a determining unit 33 and a sending unit 34.

The receiving unit 31 is configured to receive a video program acquiring request sent by a client, where the video program acquiring request carries identification information of a video program and an IP address of the client. The receiving unit 31 is a main functional module in the P2P server for receiving the video program acquiring request sent by the client.

The acquiring unit 32 is configured to acquire, from a preset router list, identification information of a router whose public IP address is identical to the IP address of the client, where the preset router list preserves identification information of a plurality of routers and a public IP address corresponding to each router. The acquiring unit 32 is a main functional module in the P2P server for acquiring, from the preset router list, the identification information of the router whose public IP address is identical to the IP address of the client.

The determining unit 33 is configured to determine whether the identification information of the video program is present in a video program list corresponding to the identification information of the router. The determining unit 33 is a main functional module in the P2P server for determining whether the identification information of the video program is present in the video program list corresponding to the identification information of the router.

The sending unit 34 is configured to send the identification information of the router to the client if the identification information of the video program is present in the video program list corresponding to the identification information of the router. The sending unit 34 is a main functional module in the P2P server for sending the identification information of the router to the client.

Further, it is convenient for the client to request to acquire the video program from the router corresponding to the identification information.

The sending unit 34 is further configured to send prompt information to the client if the identification information of the video program is not present in the video program list corresponding to the identification information of the router, where the prompt information is used for prompting the client to request to acquire the video program from a CDN server.

It is to be noted that reference may be made to corresponding description of the method as shown in FIG. 1 for other corresponding description of various functional units involved with a P2P server provided by the embodiments of the present disclosure, which is not unnecessarily elaborated any more herein. In the embodiments of the present disclosure, relevant functional modules can be implemented by means of a hardware processor.

Embodiments of the present disclosure provide a P2P server. A client downloads video programs from a router whose public IP address is the same as an IP address of the client, namely, the client downloads video programs by means of the router. In this way, a defect in the prior art that a client downloads video programs by means of a CDN server is changed, a number of network hops is reduced, and a speed in downloading video programs is improved, thereby improving a speed in starting playing video programs.

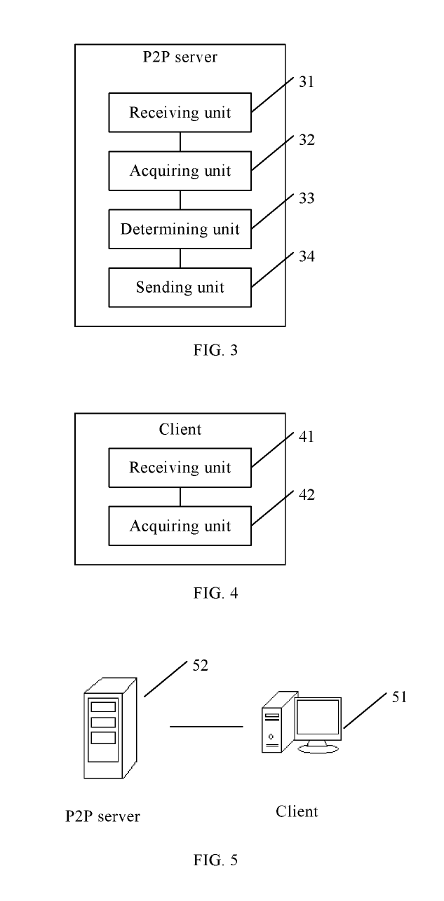

Further, as a concrete implementation of the method as shown in FIG. 2, embodiments of the present disclosure provide a client, as shown in FIG. 4, the client includes: a sending unit 41 and a receiving unit 42.

The sending unit 41 is configured to send a video program acquiring request to a P2P server, where the video program acquiring request carries identification information of a video program and an IP address of the client so that when the P2P server determines identification information of a router whose public IP address is identical to the IP address of the client and the identification information of the video program is present in a corresponding video program list, the P2P server sends the identification information of the router to the client. The sending unit 41 is a main functional module in the client for sending the video program acquiring request to the P2P server.

The receiving unit 42 is configured to receive the identification information of the router sent by the P2P server. The receiving unit 42 is a main functional module in the client for receiving the identification information of the router sent by the P2P server.

The sending unit 41 is further configured to send a video program acquiring request to a router corresponding to the identification information so that the router sends the video program. The sending unit 41 also is a main functional module in the client for sending a video program acquiring request to a router corresponding to the identification information.

The receiving unit 42 is further configured to receive the video program sent by the router. The receiving unit 42 also is a main functional module in the client for receiving the video program sent by the router.

Further, the receiving unit 42 is further configured to receive prompt information sent by the P2P server, where the prompt information is used for prompting the client to request to acquire the video program from a CDN server.

It should be explained that reference may be made to corresponding description of the method as shown in FIG. 2 for other corresponding description of various functional units involved with the client provided by the embodiments of the present disclosure, which is not repeated any more herein. In the embodiments of the present disclosure, relevant functional modules can be implemented by means of a hardware processor.

Embodiments of the present disclosure provide a client. A client downloads video programs from a router whose public IP address is the same as an IP address of the client, namely, the client downloads video programs by means of the router. In this way, a defect in the prior art that a client downloads video programs by means of a CDN server is changed, a number of network hops is reduced, and a speed in downloading video programs is improved, thereby improving a speed in starting playing video programs.

Further, embodiments of the present disclosure provide a system for acquiring a video program, as shown in FIG. 5, the system for acquiring a video program includes a client 51 and a P2P server 52.

The client 51 is configured to send a video program acquiring request to the P2P server 52, where the video program acquiring request carries identification information of a video program and an IP address of the client 51.

The P2P server 52 is configured to: acquire, from a preset router list, identification information of a router whose public IP address is identical to the IP address of the client 51, where the preset router list preserves identification information of a plurality of routers and a public IP address corresponding to each router; determine whether the identification information of the video program is present in a video program list corresponding to the identification information of the router; and send the identification information of the router to the client 51 if the identification information of the video program is present in the video program list corresponding to the identification information of the router.

The client 51 is further configured to send a video program acquiring request to a router corresponding to the identification information so that the router sends the video program.

It is to be noted that in allusion to the foregoing client, the server and the system for acquiring a video program, functions of each unit module used in the embodiment of the present disclosure may be implemented through a hardware processor.

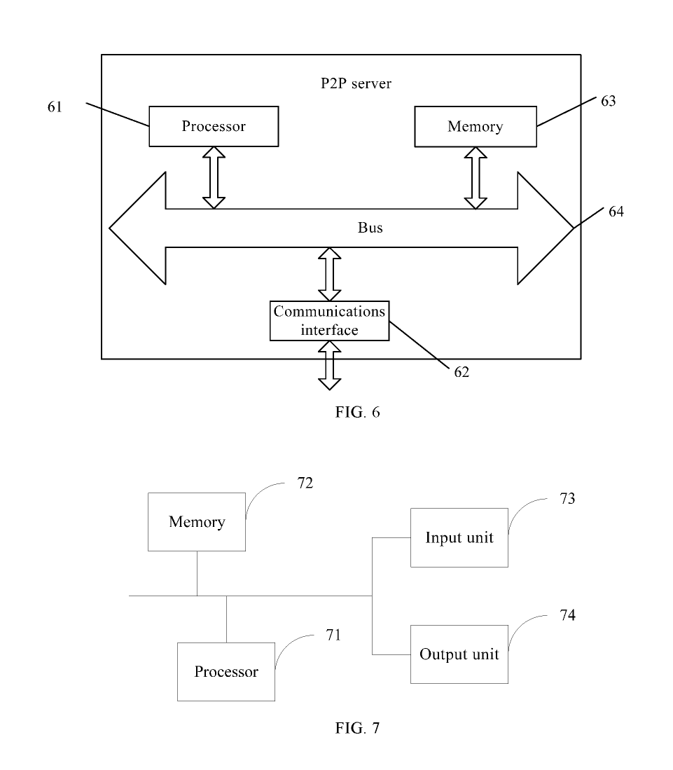

Exemplarily, as shown in FIG. 6, which shows a schematic diagram of an entity structure of a P2P server according to embodiments of the present disclosure, the P2P server can include: a processor 61, a communications interface 62, a memory 63 and a bus 64, where the processor 61, the communications interface 62 and the memory 63 complete communications among each other through the bus 64. The communications interface 62 can be configured to implement information transmission between the P2P server and the client. The processor 61 can invoke logic instructions in the memory 63 to execute the following method: it is received a video program acquiring request sent by a client, where the video program acquiring request carries identification information of a video program and an IP address of the client; it is acquired, from a preset router list, identification information of a router whose public IP address is identical to the IP address of the client, where the preset router list preserves identification information of a plurality of routers and a public IP address corresponding to each router; it is determined whether the identification information of the video program is present in a video program list corresponding to the identification information of the router, where the video program list preserves identification information of different video programs; and the identification information of the router is sent to the client if the identification information is present so that the client requests to acquire the video program from the router corresponding to the identification information.

In addition, when a logic instruction in the foregoing memory 63 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Embodiments of the present disclosure provide a system for acquiring a video program. A client downloads video programs from a router whose public IP address is the same as an IP address of the client, namely, the client downloads video programs by means of the router. In this way, a defect in the prior art that a client downloads video programs by means of a CDN server is changed, a number of network hops is reduced, and a speed in downloading video programs is improved, thereby improving a speed in starting playing video programs.

FIG. 7 is a block diagram of an electronic device which is configured to perform the methods for acquiring a video program according to an embodiment of the present disclosure. As shown in FIG. 7, the device includes:

one or more processors 71 and memory 72. A processor 71 is showed in FIG. 7 for an example.

Device which is configured to perform the methods for acquiring a video program can also include: input unit 73 and output unit 74.

Processor 71, memory 72, input unit 73 and output unit 74 can be connected by BUS or other methods, and BUS connecting is showed in FIG. 7 for an example.

Memory 72 can be used for storing non-transitory software program, non-transitory computer executable program and modules as a non-transitory computer-readable storage medium, such as corresponding program instructions/modules for the methods for acquiring a video program mentioned by embodiments of the present disclosure (such as shown in FIG. 3, receiving unit 31, acquiring unit 32, determining unit 33 and sending unit 34). Processor 71 performs kinds of functions and acquiring a video program of the electronic device by executing non-transitory software program, instructions and modules which are stored in memory 72, thereby realizes the methods for acquiring a video program mentioned by embodiments of the present disclosure.

Memory 72 can include program storage area and data storage area, thereby the operating system and applications required by at least one function can be stored in program storage area and data created by using the device for acquiring a video program can be stored in data storage area. Furthermore, memory 72 can include high speed Random-access memory (RAM) or non-volatile memory such as magnetic disk storage device, flash memory device or other non-volatile solid state storage devices. In some embodiments, memory 72 can include long-distance setup memories relative to processor 71, which can communicate with the device for acquiring a video program by networks. The examples of said networks are including but not limited to Internet, Intranet, LAN, mobile Internet and their combinations.

Input unit 73 can be used to receive inputted number, character information and key signals causing user configures and function controls of the device for acquiring a video program. Output unit 74 can include a display screen or a display device.

The said module or modules are stored in memory 72 and perform the methods for acquiring a video program when executed by one or more processors 71.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

Further, an embodiment of the present disclosure further provides a non-transitory computer-readable storage medium storing executable instructions, wherein the executable instructions are configured to perform any methods for acquiring a video program mentioned by embodiments of the present disclosure.

Finally, it should be noted that, persons of ordinary skill in the art can understand that all or part of the steps in each method according to the embodiments of the present disclosure may be implemented by a program instructing relevant hardware, and the program may be stored in a computer-readable storage medium. When the program is run, steps of each method according to the embodiments of the present disclosure are performed. The storage medium may be a magnetic disk, an optical disk, a read-only memory (ROM), a random access memory (RAM), and so on.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for acquiring a video program, applied to a P2P server, comprising:
receiving, by the P2P server, a video program acquiring request sent by a client, wherein the video program acquiring request carries identification information of a video program and an IP address of the client;
acquiring, from a preset router list, identification information of a router whose public IP address is identical to the IP address of the client, wherein the preset router list preserves identification information of a plurality of routers and a public IP address corresponding to each router;
determining whether the identification information of the video program is present in a video program list corresponding to the identification information of the router; and
sending the identification information of the router to the client if the identification information is present so that the client requests to acquire the video program from the router corresponding to the identification information.

2. The method according to claim 1, wherein after the determining whether the identification information of the video program is present in a video program list corresponding to the identification information of the router, the method further comprises:
sending prompt information to the client if the identification information is not present, wherein the prompt information is used for prompting the client to request to acquire the video program from a CDN server.

3. A method for acquiring a video program, applied to a client, comprising:
sending a video program acquiring request by the client to a P2P server, wherein the video program acquiring request carries identification information of a video program and an IP address of the client so that when the P2P server determines identification information of a router whose public IP address is identical to the IP address of the client and the identification information of the video program is present in a corresponding video program list, the P2P server sends the identification information of the router to the client;
receiving the identification information of the router sent by the P2P server;
sending a video program acquiring request to a router corresponding to the identification information so that the router sends the video program; and
receiving the video program sent by the router.

4. The method according to claim 3, wherein after the sending a video program acquiring request to a P2P server, the method further comprises:
receiving prompt information sent by the P2P server, wherein the prompt information is used for prompting the client to request to acquire the video program from a CDN server.

5. An electronic device, comprising:
at least one processor;
and a memory communicably connected with the at least one processor for storing instructions executable by the at least one processor, wherein execution of the instructions by the at least one processor causes the at least one processor to:
receive a video program acquiring request sent by a client, wherein the video program acquiring request carries identification information of a video program and an IP address of the client;
acquire, from a preset router list, identification information of a router whose public IP address is identical to the IP address of the client, wherein the preset router list preserves identification information of a plurality of routers and a public IP address corresponding to each router;
determine whether the identification information of the video program is present in a video program list corresponding to the identification information of the router; and
send the identification information of the router to the client if the identification information is present so that the client requests to acquire the video program from the router corresponding to the identification information.

6. The electronic device according to claim 5, wherein after the determining whether the identification information of the video program is present in a video program list corresponding to the identification information of the router, the instructions are executed to cause the at least one processor to:
send prompt information to the client if the identification information is not present, wherein the prompt information is used for prompting the client to request to acquire the video program from a CDN server.
